(19) United States
(12) Patent Application Publication
(10) Pub. No.: US 2015/0084516 A1
(43) Pub. Date: Mar. 26, 2015

(54) LED-BASED LIGHTING APPARATUS WITH LOW FLICKER

(71) Applicant: VastView Technology Inc., Hsinchu County (TW)

(72) Inventors: Hung-Chi Chu, Hsinchu County (TW); YuhRen Shen, Hsinchu County (TW)

(73) Assignee: VastView Technology Inc., Hsinchu County (TW)

(21) Appl. No.: 14/034,808

(22) Filed: Sep. 24, 2013

(51) Int. Cl. H05B 33/08

(52) U.S. Cl. CPC H05B 33/0809; H05B 33/0812
USPC 315/140; 315/139

(57) ABSTRACT

An LED-based lighting apparatus is powered by multi-phase AC voltages to reduce flicker. A multi-phase AC-to-AC power generator is used to generate a plurality of AC voltages from an AC power source. The plurality of AC voltages each having a different phase are rectified by a plurality of rectifiers to provide a plurality of rectified AC voltages for a plurality of LED lighting units. Each LED lighting unit has voltage dependent brightness and reaches maximum brightness at different time due to the phase difference in the rectified AC voltage. The peak-to-peak variation in the total brightness is reduced and therefore the LED-based lighting apparatus has low flicker.

### BACKGROUND OF THE INVENTION

1. Field of the Invention

The present invention relates generally to light emitting diode (LED) based lighting apparatus, and more particularly to an apparatus and method for driving LED based lighting units with low flicker.

2. Description of Related Arts

LEDs are semiconductor-based light sources often employed in low-power instrumentation and appliance applications for indication purposes in the past. The application of LEDs in various lighting units has also become more and more popular. For example, high brightness LEDs have been widely used for traffic lights, vehicle indicating lights, and braking lights. In recent years, high voltage LED-based lighting apparatus have been developed to replace the conventional incandescent and fluorescent lamps.

In order to increase the brightness of an LED light, a number of LEDs are usually connected in series to form an LED-based lighting string and a number of LED-based lighting strings may further be connected in series to form a lighting apparatus. The operating voltage required by each lighting string typically is related to the forward voltage of the LEDs in each lighting string, how many LEDs are employed for each of the lighting string and how they are interconnected, and how the respective lighting strings are organized to receive power from a power source.

Accordingly, in many applications, some type of voltage conversion device is required in order to provide a generally lower operating voltage to one or more LED-based lighting strings from more commonly available higher power supply voltages. The need of a voltage conversion device reduces the efficiency, costs more and also makes it difficult to miniaturize an LED-based lighting apparatus.

In order to increase the efficiency and miniaturize the LED-based lighting apparatus, many techniques have been developed for the apparatus to use operating voltages such as 120V AC or 240V AC without requiring a voltage conversion device. In general, the LEDs in the apparatus are divided into a number of LED segments that can be selectively turned on or off by associated switches or current sources, and a controller is used to control the switches or current sources as the operating AC voltage increases or decreases.

FIG. 1 shows a block diagram of a conventional LED-based lighting apparatus powered by an AC voltage source. The AC voltage is rectified by a rectifier 110 to generate a rectified AC voltage. An LED lighting unit 101 receives the rectified AC voltage as the input voltage.

Such an LED-based lighting apparatus has a simple structure and can be manufactured with low cost. However, because the AC voltage is not regulated, the brightness of the LED lighting unit changes with the variation of the input voltage. As a result, the LED-based lighting apparatus has higher flicker. To make the LED-based lighting apparatus more acceptable in the households for replacing the conventional incandescent and fluorescent lamps, there is a strong need in reducing the flicker.

### SUMMARY OF THE INVENTION

The present invention has been made to provide an LED-based lighting apparatus with low flicker. Accordingly, the LED-based lighting apparatus is powered with rectified multi-phase AC voltages in order to reduce the peak-to-peak variation of the brightness of the lighting apparatus.

In a first preferred embodiment of the present invention, the LED-based lighting apparatus comprises an AC power source, a multi-phase AC-to-AC power generator for generating a plurality of AC voltages with different phases, and a plurality of rectifiers for rectifying the plurality of AC voltages. A plurality of LED lighting units with voltage dependent brightness is powered by the plurality of rectified AC voltages.

In a second preferred embodiment, the LED-based lighting apparatus comprises an AC power source, and a multi-phase AC-to-AC power generator for generating a plurality of AC voltages with different phases. A plurality of LED AC driving units with voltage dependent brightness is powered by the plurality of AC voltages.

In a third preferred embodiment of the present invention, the LED-based lighting apparatus comprises an AC power source, a multi-phase AC-to-AC power generator for generating a plurality of AC voltages with different phases, and a plurality of rectifiers for rectifying the plurality of AC voltages. The plurality of rectified AC voltages are connected in parallel to supply power to a single LED lighting unit with voltage dependent brightness.

### BRIEF DESCRIPTION OF THE DRAWINGS

The present invention will be apparent to those skilled in the art by reading the following detailed description of preferred embodiments thereof, with reference to the attached drawings, in which:

FIG. 1 shows a block diagram of a conventional LED-based lighting apparatus powered by a rectified AC voltage source;

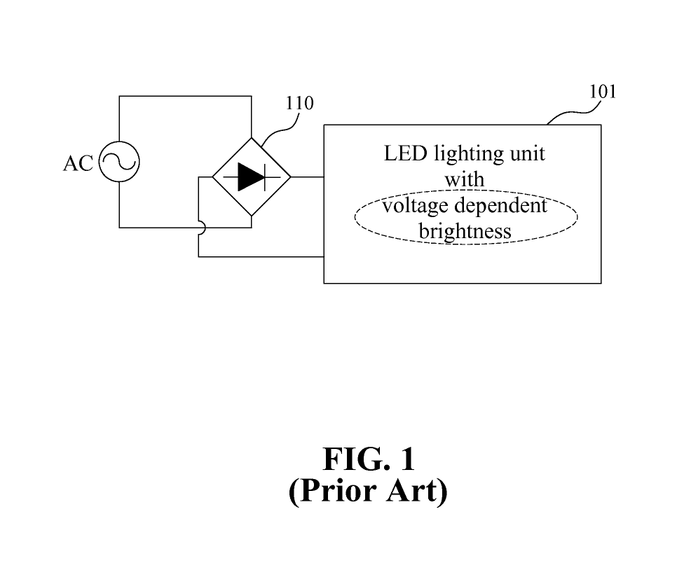

FIG. 2 shows a block diagram of an LED-based lighting apparatus having a multi-phase AC-to-AC power generator according to a first preferred embodiment of the present invention;

FIG. 3 shows an example of the LED lighting unit used in the first preferred embodiment of the present invention;

FIG. 4 shows a block diagram of an example of an LED-based lighting apparatus having a two-phase AC power source according to the first preferred embodiment of the present invention;

FIG. 5A shows the voltage levels of the two-phase AC power used in the LED-based lighting apparatus shown in FIG. 4 and FIG. 5B shows the voltage levels after the two-phase AC power is rectified;

FIG. 6 shows a block diagram of an example of an LED-based lighting apparatus having a three-phase AC power source according to the first preferred embodiment of the present invention;

FIG. 7A shows the voltage levels of the three-phase AC power used in the LED-based lighting apparatus shown in FIG. 6 and FIG. 7B shows the voltage levels after the three-phase AC power is rectified;

FIG. 8 shows the brightness of the three LED lighting units in the apparatus shown in FIG. 6 as the three-phase AC voltages vary with time;

FIG. 9 compares the brightness of an LED lighting unit provided with a single phase AC power and the LED-based lighting apparatus having three LED lighting units provided with three-phase AC power.

FIG. 10 compares the crest factors of LED-based lighting apparatuses with single-phase, two-phase and three-phase AC power according to the present invention, a fluorescent lamp and a filament lamp.

FIG. 11 shows a block diagram of an LED-based lighting apparatus having a multi-phase AC-to-AC power generator according to a second preferred embodiment of the present invention;

FIG. 12 shows a block diagram of an example of an LED-based lighting apparatus having a three-phase AC power source according to the second preferred embodiment of the present invention;

FIG. 13 shows a block diagram of an LED-based lighting apparatus having a multi-phase AC-to-AC power generator according to a third preferred embodiment of the present invention;

FIG. 14 shows a block diagram of an example of an LED-based lighting apparatus having a three-phase AC power source according to the third preferred embodiment of the present invention;

FIG. 15A shows the voltage levels of the three-phase AC power used in the LED-based lighting apparatus shown in FIG. 14 and FIG. 15B shows the voltage levels after the three-phase AC power is rectified; and

FIG. 16 compares the crest factors of the LED-based lighting apparatuses according to the first and third preferred embodiments of the present invention.

FIG. 17 shows an example of connecting N multi-phase AC voltages directly to a plurality of rectifiers without using a multi-phase AC-to-AC power generator.

### DETAILED DESCRIPTION OF THE PREFERRED EMBODIMENT

The accompanying drawings are included to provide a further understanding of the invention, and are incorporated in and constitute a part of this specification. The drawing illustrates embodiments of the invention and, together with the description, serves to explain the principles of the invention.

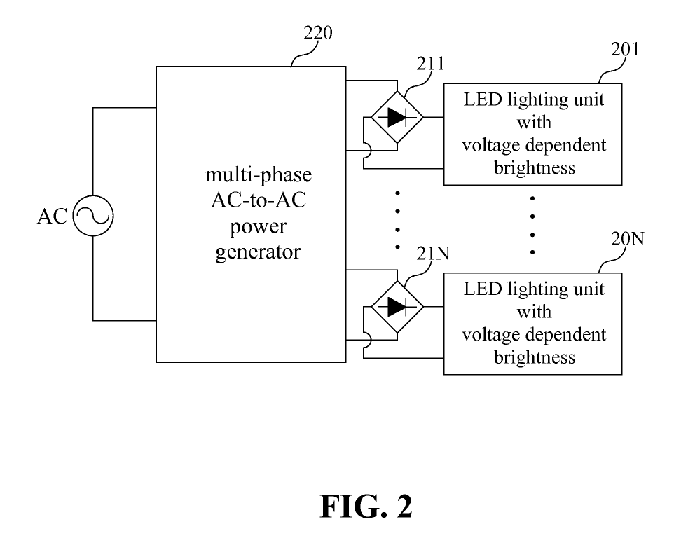

FIG. 2 shows a block diagram of an LED-based lighting apparatus with low flicker using multi-phase AC voltages according to a first preferred embodiment of the present invention. In the embodiment, the apparatus comprises a multi-phase AC-to-AC power generator 220, a plurality of rectifiers 211-21N and a plurality of LED lighting units 201-20N. The multi-phase AC-to-AC power generator 220 generates a plurality of AC voltages each having a different phase from an AC power source. The different phases may be uniformly or non-uniformly distributed. Each AC voltage is coupled to one rectifier to provide a rectified AC voltage to one LED lighting unit.

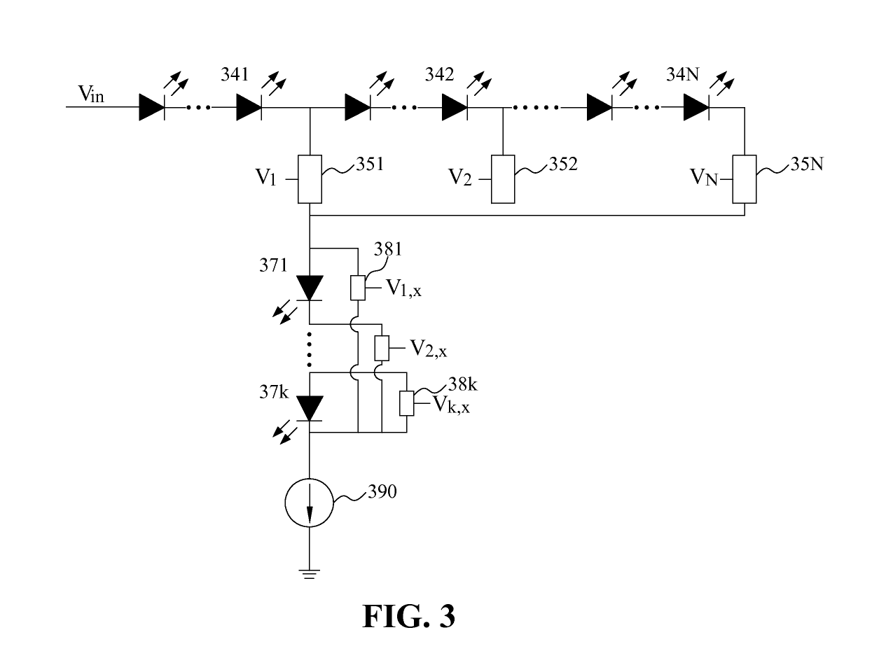

FIG. 3 shows an example of the LED lighting unit used in the apparatus of FIG. 2. The LED lighting unit comprises a first plurality of LEDs divided into a plurality of LED segments 341-34N. Each LED segment has a positive end and a negative end connected respectively to the negative end of its preceding LED segment and the positive end of its following LED segment. As can be seen in FIG. 3, the negative end of each LED segment is further connected to a first terminal of a three-terminal voltage controlled current limiting device. The second terminals of the three-terminal voltage controlled limiting devices 351-35N are connected respectively to bias voltages V₁-V_{N} and the third terminals are connected to a common node.

As can also be seen in FIG. 3, the LED lighting unit further comprises a second plurality of LEDs connected between the common node and the current source 390. The second plurality of LEDs is divided into a plurality of LED segments 371-37k. For simplicity, only one LED is shown in each LED segment 371-37k. A plurality of three-terminal voltage controlled current limiting devices 381-38k are connected in parallel with the plurality of LED segments 371-37k. Each of the three-terminal voltage controlled current limiting devices 371-37k has a first terminal connected to the positive end of one of the LED segments 371-37k, a third terminal connected to a first end of the current source 390 and a second terminal applied with a bias voltage V_{1,x}-V_{k,x}.

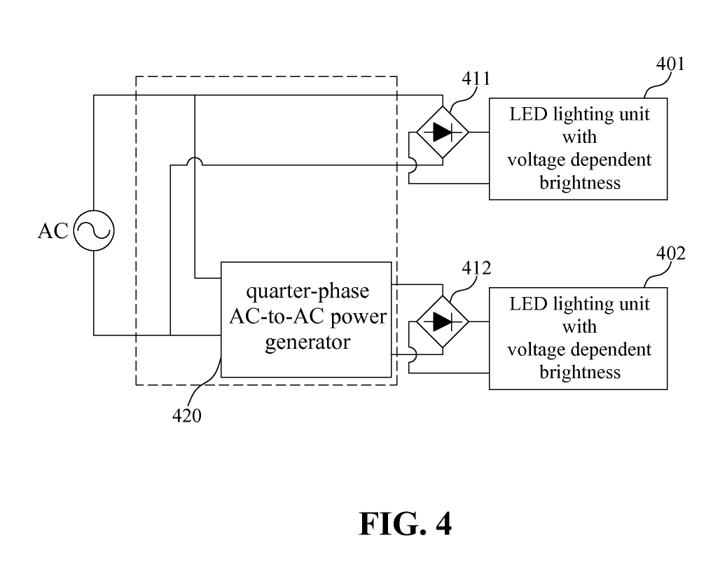

FIG. 4 shows an example of the first preferred embodiment in which a quarter-phase AC-to-AC power generator 420 is used to generate two phase AC voltages. The two phase AC voltages are respectively coupled to two rectifiers 411 and 412. The rectified two phase AC voltages are then applied to the two LED lighting units 401 and 402.

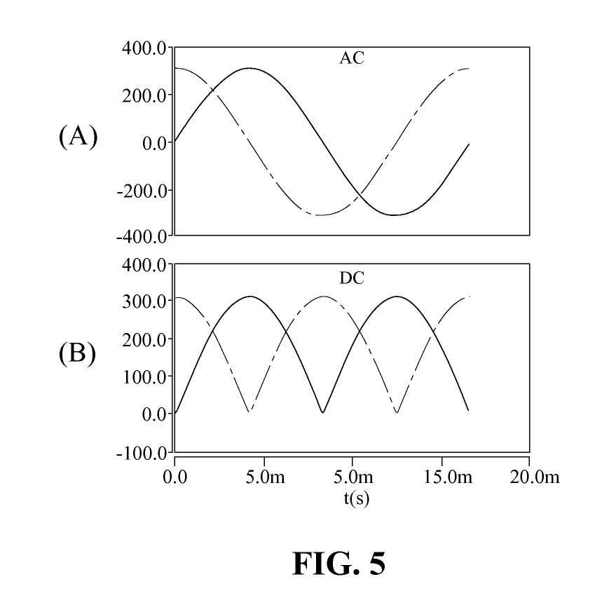

FIG. 5A shows the voltage levels of the two phase AC voltages generated in the apparatus of FIG. 4 from a single phase 220V AC power source. FIG. 5B shows the rectified two phase 220V AC voltages. As shown in FIG. 4, in this example of the first preferred embodiment, the two LED lighting units 401, 402 are respectively supplied with rectified AC voltages that have 90 degree phase shift from each other.

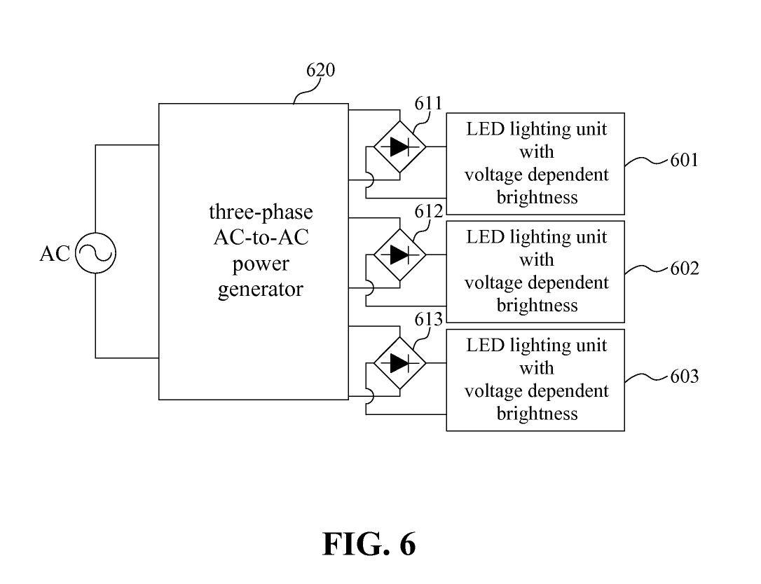

FIG. 6 shows another example of the first preferred embodiment in which a three-phase AC-to-AC power generator 620 is used to generate three phase AC voltages. The three phase AC voltages are respectively coupled to three rectifiers 611, 612 and 613. The rectified three phase AC voltages are then applied to the three LED lighting units 601, 602 and 603.

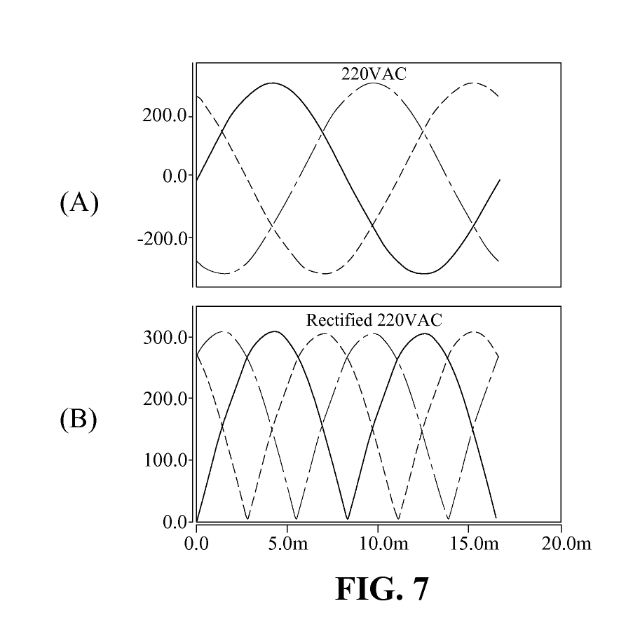

FIG. 7A shows the voltage levels of the three phase AC voltages generated by the three-phase AC-to-AC power generator 620 from a single phase 220V AC power source. FIG. 7B shows the rectified three phase 220V AC voltages. As shown in FIG. 6, in this example of the first preferred embodiment, each LED lighting unit 601, 602, 603 is supplied with a respective rectified 220V AC voltage. The three rectified 220V AC voltages have different phases.

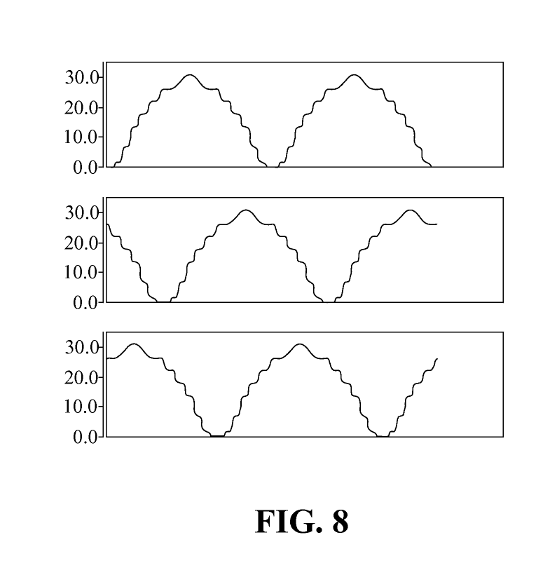

FIG. 8 shows the brightness of three LED lighting units supplied with the rectified AC voltages shown in FIG. 7B. The brightness of each LED lighting unit varies with the rectified AC voltages. Because the three rectified AC voltages have different phases, each LED lighting unit reaches its maximum brightness at different time. The total brightness of the LED-based lighting apparatus in the first preferred embodiment is the summation of the brightness of all the LED lighting units. As a result, the peak-to-peak variation of the total brightness is decreased and the flicker of the lighting apparatus is also reduced.

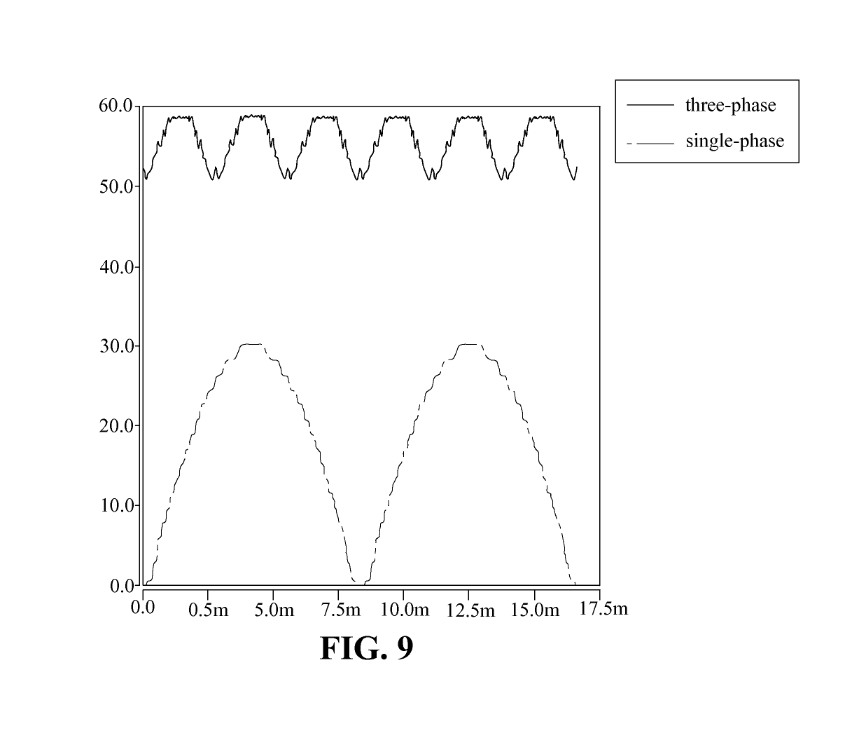

FIG. 9 compares the brightness of an LED lighting unit provided with a single phase AC voltage and the LED-based lighting apparatus having three LED lighting units provided with rectified three-phase AC voltages according to the first preferred embodiment of the present invention. As can be seen in FIG. 9, the peak-to-peak variation of the brightness resulted from the three LED lighting units using three-phase AC voltages is significantly less than the variation resulted from the LED lighting unit using a single phase AC voltage.

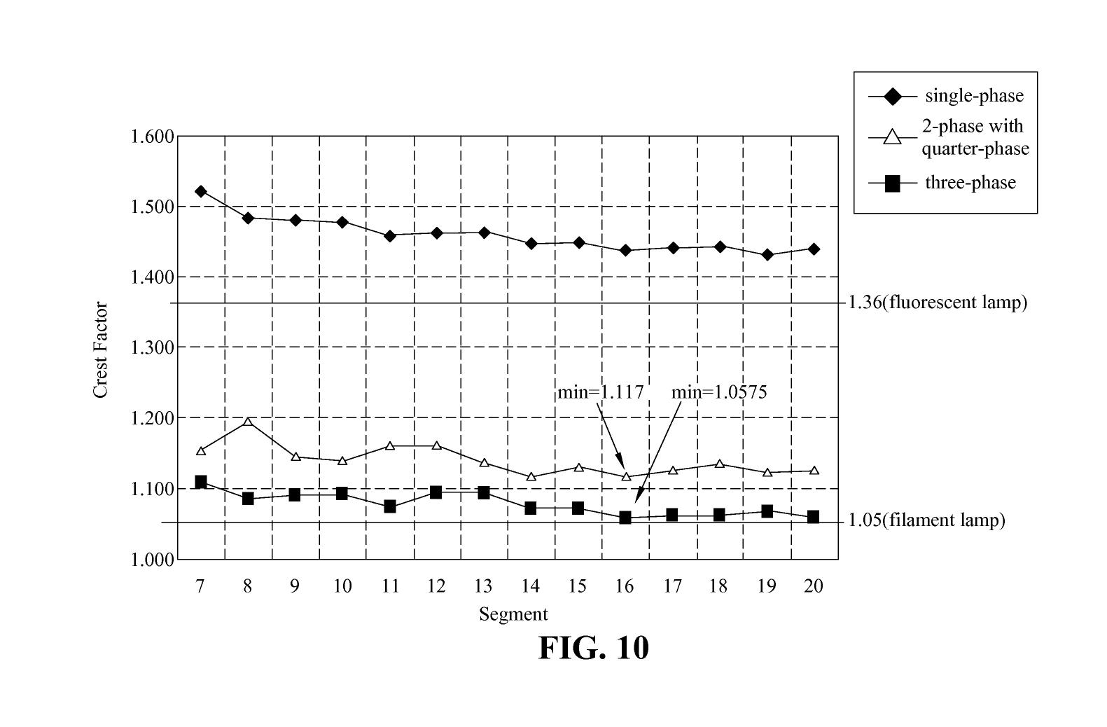

In order to illustrate the reduction in flicker, a crest factor which is commonly used as a flicker index is studied for the LED-based lighting apparatus according to the first preferred embodiment. The crest factor is defined as the ratio of the peak level to the root-mean-square level of the light generated by a lighting apparatus. FIG. 10 shows the crest factors for the LED-based lighting apparatuses powered by rectified single-phase, two-phase with quarter-phase and three-phase AC voltages.

As can be seen in FIG. 10, the lighting apparatuses with rectified two-phase and three-phase AC voltages have much lower crest factors. The crest factor of the lighting apparatus with rectified three-phase AC voltages is very close to that of a filament lamp. The crest factor of the lighting apparatus with a rectified single-phase AC voltage is higher than that of a fluorescent lamp. How the crest factor changes as a function of the number of LED segments in the LED lighting unit is also shown in the figure.

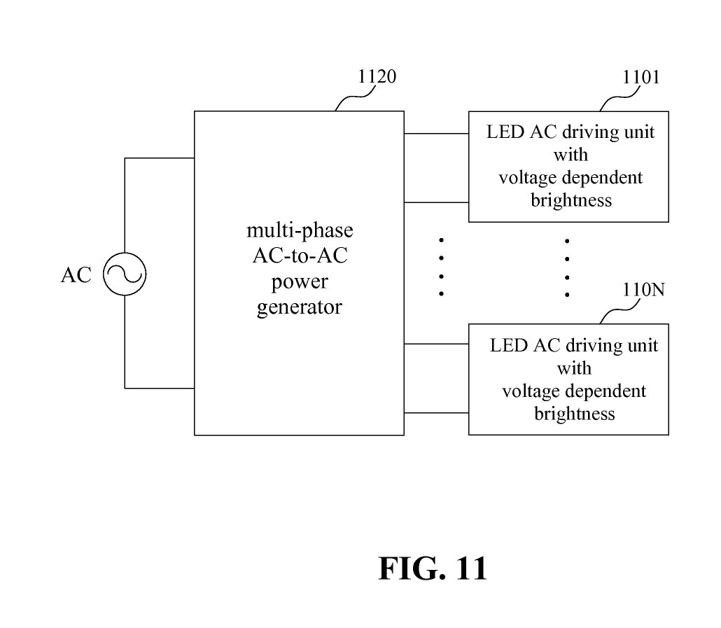

FIG. 11 shows a block diagram of an LED-based lighting apparatus with low flicker using multi-phase AC voltages according to a second preferred embodiment of the present invention. In the second embodiment, the apparatus comprises a multi-phase AC-to-AC power generator 1120 and a plurality of LED AC driving units 1101-110N. The multi-phase AC-to-AC power generator 1120 generates a plurality of AC voltages each having a different phase. The different phases may be uniformly or non-uniformly distributed. Each AC voltage is coupled directly to one LED AC driving unit whose brightness varies with the input voltage.

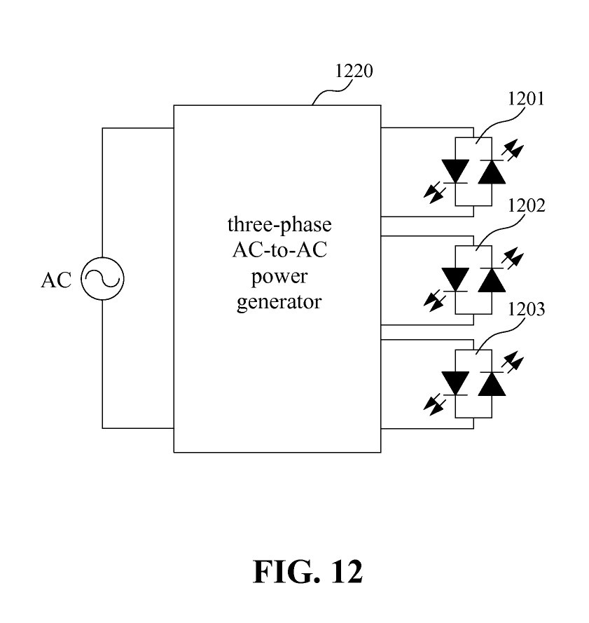

FIG. 12 shows an example of the second preferred embodiment in which a three-phase AC-to-AC power generator 1220 is used to generate three phase AC voltages. The three phase AC voltages are respectively coupled to three LED AC driving units 1201, 1202 and 1203. Each LED AC driving unit has at least one set of LEDs connected in series and another set of LEDs connected in series with polarity being reversed. The two sets of LEDs are connected in parallel.

For simplicity, FIG. 12 shows that each LED AC driving unit has two LEDs connected in parallel with polarity being reversed. As can be understood from FIG. 12, each LED AC driving unit has one of the LEDs turned on regardless whether the AC voltage has positive or negative values.

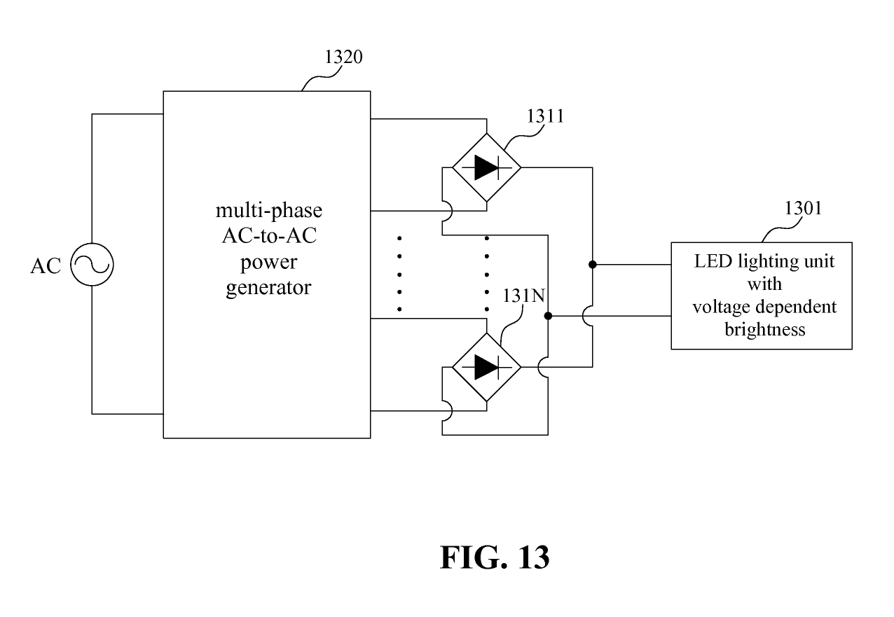

FIG. 13 shows a block diagram of an LED-based lighting apparatus with low flicker using multi-phase AC voltages according to a third preferred embodiment of the present invention. In the third embodiment, the apparatus comprises a multi-phase AC-to-AC power generator 1320, a plurality of rectifiers 1311-131N and one LED lighting unit 1301. The multi-phase AC-to-AC power generator 1320 generates a plurality of AC voltages each having a different phase. The different phases may be uniformly or non-uniformly distributed. Each AC voltage is coupled to one rectifier to provide a rectified AC voltage of a single phase. The rectified multi-phase AC voltages are connected in parallel.

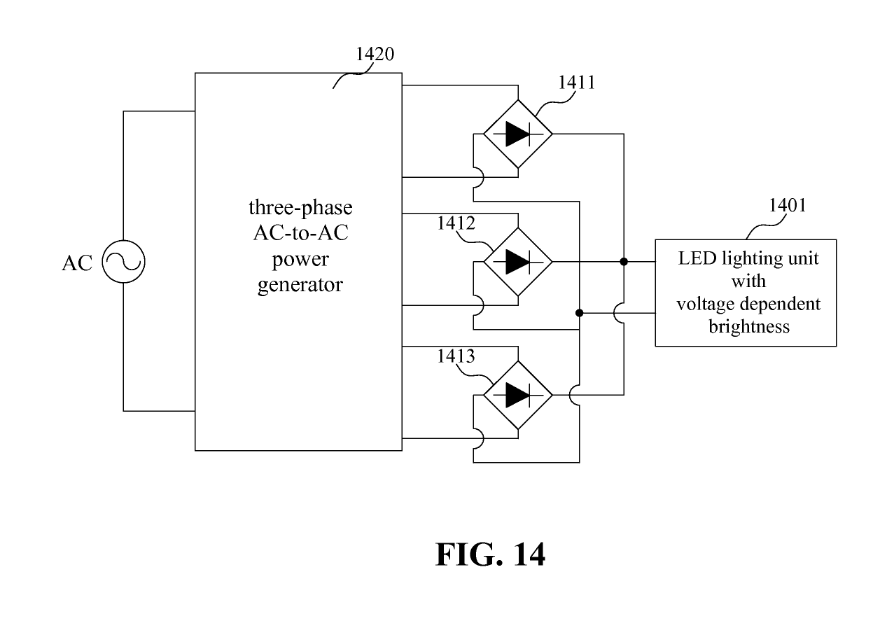

According to the present invention, the LED lighting unit shown in FIG. 3 can also be used in the third preferred embodiment. As can be seen in FIG. 13, all the rectified AC voltages are connected to the LED lighting unit 1301. FIG. 14 shows an example of the third preferred embodiment in which a three-phase AC-to-AC power generator 1420 is used to generate three phase AC voltages. The three phase AC voltages are respectively coupled to three rectifiers 1411, 1412 and 1413. The rectified three phase AC voltages are then applied to the LED lighting unit 1401.

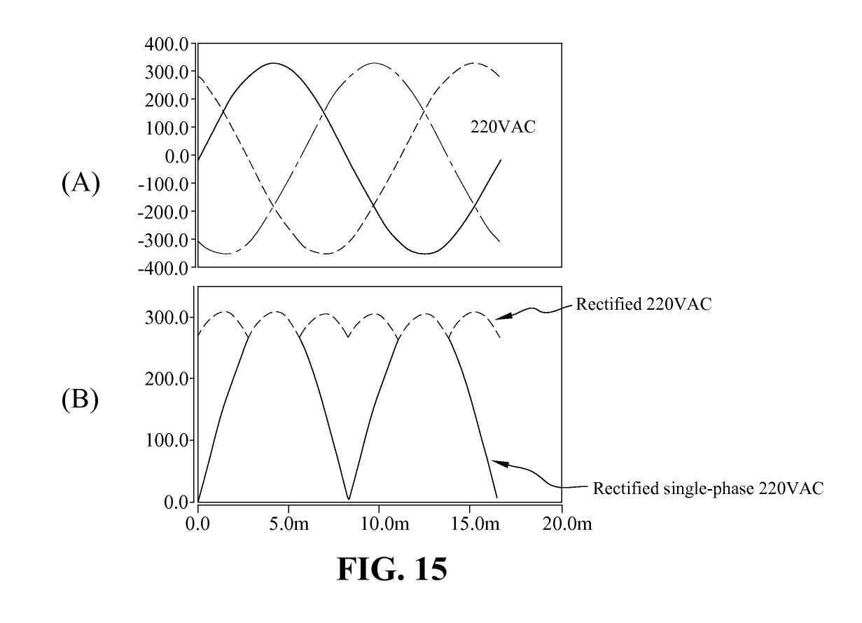

FIG. 15A shows the voltage levels of the three phase AC voltages generated by the three-phase AC-to-AC power generator 1420 from a single phase 220V AC power source. FIG. 15B shows the voltage levels of a rectified single-phase 220V AC voltage and the rectified three-phase AC voltage applied to the LED lighting unit 1401. Because three rectified 220V AC voltages of different phases are connected in parallel as the rectified three phase 220V AC voltage, the voltage level applied to the LED lighting unit 1401 is equal to the maximum of the absolute magnitude of all the individual rectified AC voltages. As a result, the peak-to-peak variation of the rectified voltage is reduced and the brightness of the LED lighting unit has low flicker.

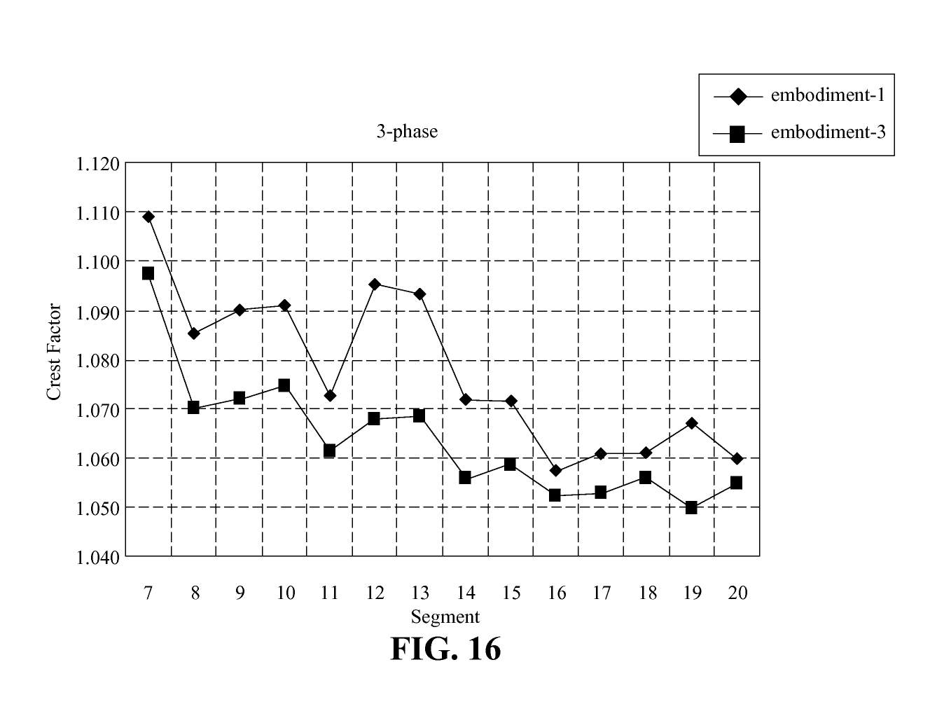

FIG. 16 shows the crest factors for the LED-based lighting apparatuses powered by rectified three-phase AC voltages according to the first and third preferred embodiments. The crest factor is presented as a function of the number of LED segments in the LED lighting unit. As can be seen in FIG. 16, the LED lighting apparatus of the third embodiment has a lower crest factor than the first embodiment.

It is worth mentioning that although in the above embodiments, a single AC power source is used to generate the plurality of AC voltages by means of a multi-phase AC-to-AC power generator, when multi-phase AC voltages are readily available, they can also be applied directly to the plurality of rectifiers without having to use a multi-phase AC-to-AC power generator.

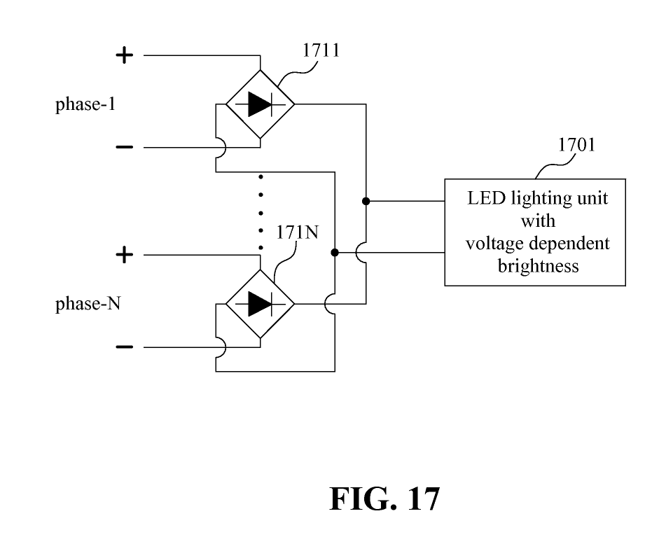

For example, as shown in FIG. 17, N multi-phase AC voltages, phase-1 to phase-N, are connected directly to a plurality of rectifiers 1711-171N without using a multi-phase AC-to-AC power generator. All the rectified AC voltages are connected to the LED lighting unit 1701.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An LED-based lighting apparatus, comprising:
a plurality of AC voltages each having a different phase;
a plurality of rectifiers coupled respectively to said plurality of AC voltages to generate a plurality of rectified AC voltages; and
a plurality of LED lighting units connected respectively to said plurality of rectified AC voltages;
wherein each of said plurality of LED lighting unit has voltage dependent brightness.

2. The LED-based lighting apparatus as claimed in claim 1, wherein the different phases of said plurality of AC voltages are uniformly distributed.

3. The LED-based lighting apparatus as claimed in claim 1, wherein the different phases of said plurality of AC voltages are non-uniformly distributed.

4. The LED-based lighting apparatus as claimed in claim 1, further comprising:
an AC power source; and
a multi-phase AC-to-AC power generator connected to said AC power source to generate said plurality of AC voltages.

5. The LED-based lighting apparatus as claimed in claim 4, wherein said multi-phase AC-to-AC power generator includes a quarter-phase AC-to-AC power generator and said plurality of AC voltages comprises two AC voltages with 90 degree phase shift.

6. The LED-based lighting apparatus as claimed in claim 4, wherein said multi-phase AC-to-AC power generator is a three-phase AC-to-AC power generator.

7. The LED-based lighting apparatus as claimed in claim 1, wherein each of said plurality of LED lighting units comprises:
a first plurality of LEDs divided into a first plurality of LED segments connected in series, each of said first plurality LED segments having a positive end and a negative end;
a first plurality of voltage controlled current limiting devices, each of said first plurality of voltage controlled current limiting devices being associated with one of said first plurality of LED segments, and having a first terminal connected to the negative end of the associated LED segment, a second terminal being applied with a bias voltage and a third terminal being connected to a first common node;
a second plurality of LEDs divided into a second plurality of LED segments connected in series, each of said second plurality LED segments having a positive end and a negative end, the positive end of a leading LED segment of said second plurality of LED segments being connected to said first common node and the negative end of a last LED segment of said second plurality of LED segments being connected to a second common node;
a second plurality of voltage controlled current limiting devices, each of said second plurality of voltage controlled current limiting devices being associated with one of said second plurality of LED segments, and having a first terminal connected to the positive end of the associated LED segment, a second terminal being applied with a bias voltage and a third terminal being connected to said second common node; and
a current source having a first end connected to said second common node and a second end connected to ground.

8. An LED-based lighting apparatus, comprising:
a plurality of AC voltages each having a different phase; and
a plurality of LED AC driving units connected respectively to said plurality of AC voltages;
wherein each of said plurality of LED AC driving unit has voltage dependent brightness.

9. The LED-based lighting apparatus as claimed in claim 8, wherein the different phases of said plurality of AC voltages are uniformly distributed.

10. The LED-based lighting apparatus as claimed in claim 8, wherein the different phases of said plurality of AC voltages are non-uniformly distributed.

11. The LED-based lighting apparatus as claimed in claim 8, further comprising:
an AC power source; and
a multi-phase AC-to-AC power generator connected to said AC power source to generate said plurality of AC voltages.

12. The LED-based lighting apparatus as claimed in claim 11, wherein said multi-phase AC-to-AC power generator includes a quarter-phase AC-to-AC power generator and said plurality of AC voltages comprises two AC voltages with 90 degree phase shift.

13. The LED-based lighting apparatus as claimed in claim 11, wherein said multi-phase AC-to-AC power generator is a three-phase AC-to-AC power generator.

14. The LED-based lighting apparatus as claimed in claim 8, wherein each of said plurality of LED AC driving units comprises at least two sets of LEDs connected in parallel with reversed polarity, each set of LEDs having one or more LEDs connected in series.

15. An LED-based lighting apparatus, comprising:
a plurality of AC voltages each having a different phase;
a plurality of rectifiers coupled respectively to said plurality of AC voltages to generate a plurality of rectified AC voltages, said plurality of rectified AC voltages being connected in parallel; and
an LED lighting unit connected to said plurality of rectified AC voltages;
wherein said plurality of LED lighting unit has voltage dependent brightness.

16. The LED-based lighting apparatus as claimed in claim 15, wherein the different phases of said plurality of AC voltages are uniformly distributed.

17. The LED-based lighting apparatus as claimed in claim 15, wherein the different phases of said plurality of AC voltages are non-uniformly distributed.

18. The LED-based lighting apparatus as claimed in claim 15, further comprising:
an AC power source; and
a multi-phase AC-to-AC power generator connected to said AC power source to generate said plurality of AC voltages.

19. The LED-based lighting apparatus as claimed in claim 18, wherein said multi-phase AC-to-AC power generator includes a quarter-phase AC-to-AC power generator and said plurality of AC voltages comprises two AC voltages with 90 degree phase shift.

20. The LED-based lighting apparatus as claimed in claim 18, wherein said multi-phase AC-to-AC power generator is a three-phase AC-to-AC power generator.

21. The LED-based lighting apparatus as claimed in claim 15, wherein said LED lighting unit comprises:
a first plurality of LEDs divided into a first plurality of LED segments connected in series, each of said first plurality LED segments having a positive end and a negative end;
a first plurality of voltage controlled current limiting devices, each of said first plurality of voltage controlled current limiting devices being associated with one of said first plurality of LED segments, and having a first terminal connected to the negative end of the associated LED segment, a second terminal being applied with a bias voltage and a third terminal being connected to a first common node;
a second plurality of LEDs divided into a second plurality of LED segments connected in series, each of said second plurality LED segments having a positive end and a negative end, the positive end of a leading LED segment of said second plurality of LED segments being connected to said first common node and the negative end of a last LED segment of said second plurality of LED segments being connected to a second common node;
a second plurality of voltage controlled current limiting devices, each of said second plurality of voltage controlled current limiting devices being associated with one of said second plurality of LED segments, and having a first terminal connected to the positive end of the associated LED segment, a second terminal being applied with a bias voltage and a third terminal being connected to said second common node; and
a current source having a first end connected to said second common node and a second end connected to ground.
